(19) United States
(12) Patent Application Publication
(10) Pub. No.: US 2011/0044563 A1
(43) Pub. Date: Feb. 24, 2011

(54) PROCESSING GEO-LOCATION INFORMATION ASSOCIATED WITH DIGITAL IMAGE FILES

(76) Inventors: Andrew C. Blose, Penfield, NY (US); Dale F. McIntyre, Honeoye Falls, NY (US); Kevin M. Gobeyn, Rochester, NY (US)

Correspondence Address: EASTMAN KODAK COMPANY;PATENT LEGAL STAFF, 343 STATE STREET, ROCHESTER, NY, 14650-2201, US

(21) Appl. No.: 12/546,143

(22) Filed: Aug. 24, 2009

(51) Int. Cl. G06K 9/54

(52) U.S. Cl. 382/306

(57) ABSTRACT

A method for processing geo-location information associated with a digital image file, the method implemented at least in part by a data processing system and comprising receiving a digital image file having at least associated geo-location information relating to the digital image file; providing a venue database that stores geographic boundaries for a plurality of venues; identifying a venue where the digital image file was captured, the venue being identified by at least comparing the geo-location information to the geographic boundaries stored in the venue database; and adding a metadata tag to the digital image file, the metadata tag providing an indication of the identified venue.

### FIELD OF THE INVENTION

The present invention relates generally to the field of digital image processing. In particular, various embodiments of the present invention pertain to the use of scene capture metadata associated with digital image files to provide additional context to the records.

### BACKGROUND OF THE INVENTION

Since the advent of photography, photographers have been capturing interesting subjects and scenes with their cameras. These photographs capture a moment in time at a particular location with specific content. To insure that this contextual information about the photograph is preserved, photographers performed some sort of manual operation. With film-based cameras and photographic prints, a handwritten record was often created by scribing information on the back of the print or perhaps in a notebook. This is tedious and many photographers avoid the process leaving countless photographs without information to adequately understand the content of the photograph.

With the advent of digital photography, the problem remains. While physically scribing on a digital image is impossible, “tagging” an image with ASCII text is supported by many digital image management software programs. Tagging is the process of associating and storing textual information with a digital image so that the textual information is preserved with the digital image file. While this may seem less tedious than writing on the back of a photographic print, it is relatively cumbersome and time consuming and is avoided by many digital photographers.

Other digital technologies have been applied to provide scene capture metadata for digital images. Many digital capture devices record the time of capture which is then included in the digital image. Technologies such as the Global Positioning System (GPS) and cellular phone networks have been used to determine the photographer's physical location at the time a digital photograph is taken which is then included in the digital image. Time and location are key pieces of contextual information but lack the context a photographer is capable of adding. For example, the time and location (08-12-07 14:02:41 UTC 42° 20′ 19.92″ N 76° 55′ 39.58″ W) may be recorded with the digital image by the digital capture device. However, such information, by itself, often is not very helpful for photographers.

In U.S. Pat. No. 6,914,626 Squibbs teaches a user-assisted process for determining location information for digital images using an independently-recorded location database associated with a set of digital images.

In U.S. Patent Application Publication No. 2004/0183918 Squilla, et al. teach using geo-location information to produce enhanced photographic products using supplemental content related to the location of captured digital images. However, no provision is made for enabling users to access context information for their images.

Accordingly, improved techniques for providing and improving the usefulness of contextual information associated with digital images are needed.

### SUMMARY OF THE INVENTION

The above described problem is addressed and a technical solution is achieved in the art by systems and methods for processing geo-location information associated with a digital image file, the method implemented at least in part by a data processing system and comprising:

a) receiving a digital image file having at least associated geo-location information relating to the digital image file;

b) providing a venue database that stores geographic boundaries for a plurality of venues;

c) identifying a venue where the digital image file was captured, the venue being identified by at least comparing the geo-location information to the geographic boundaries stored in the venue database; and

d) adding a metadata tag to the digital image file, the metadata tag providing an indication of the identified venue.

According to some embodiments, the present invention provides a method for providing a service that obtains contextual information for a user's digital image files. The method is implemented at least in part by a data processing system and includes receiving a digital image file; using the scene capture geo-location information from the file to identify the venue in which the image was captured; and storing an indication of the capture venue in computer memory. In some embodiments, the indication of the capture venue is associated with the digital image file and the association stored in computer memory.

According to another embodiment of the present invention, a message is transmitted to a computer system relating to the identified capture venue of a digital image file. This message can, in some embodiments, be an advertisement related to the venue. The digital image files themselves can be modified to include the capture venue in other embodiments.

According to further embodiment of the present invention, a portion of the venue can be identified using the scene capture geo-location information from the digital image file. In these embodiments a message or advertisement can be transmitted that is related to just the identified portion of the venue.

According to still another embodiment of the present invention, the scene capture time is used in conjunction with the geo-location information to identify both the venue and a specific event occurring at the venue at the time of scene capture. A message can be transmitted to a computer system indicating the capture event of a digital image file. This message can, in some embodiments, be an advertisement related to the event. The digital image files themselves can be modified to include the capture event in other embodiments.

In some embodiments, orientation-of-capture information for the scene is used in conjunction with the geo-location information to identify both the location of capture and the field-of-view captured. The field-of-view can then be used in the process of identifying the venue or the portion of the venue.

In addition to the embodiments described above, further embodiments will become apparent by reference to the drawings and by study of the following detailed description.

### BRIEF DESCRIPTION OF THE DRAWINGS

The present invention will be more readily understood from the detailed description of exemplary embodiments presented below considered in conjunction with the attached drawings, of which:

FIG. 1 illustrates a system for processing geo-location information, according to an embodiment of the present invention;

FIG. 2 illustrates a flowchart of a method for processing geo-location information, according to an embodiment of the present invention;

FIG. 3 illustrates a flowchart of a method for processing geo-location and time-of-capture information, according to an embodiment of the present invention;

FIG. 4 illustrates a practical example upon which the methods of FIGS. 2 and 3 can be executed; and

FIG. 5 illustrates another example upon which the methods of FIGS. 2 and 3 can be executed.

### DETAILED DESCRIPTION

Some embodiments of the present invention utilize digital image file scene capture information in a manner that provides much greater context for describing and tagging digital records. Some embodiments of the invention provide contextual information specific not only to the time and location of the capture of digital image files but derives information pertaining to the specific venue, event, or both where the content was captured.

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular and/or plural in referring to the “method” or “methods” and the like is not limiting.

The phrase, “digital image file”, as used herein, refers to any digital image file, such as a digital still image or a digital video file. It should be noted that, unless otherwise explicitly noted or required by context, the word “or” is used in this disclosure in a non-exclusive sense.

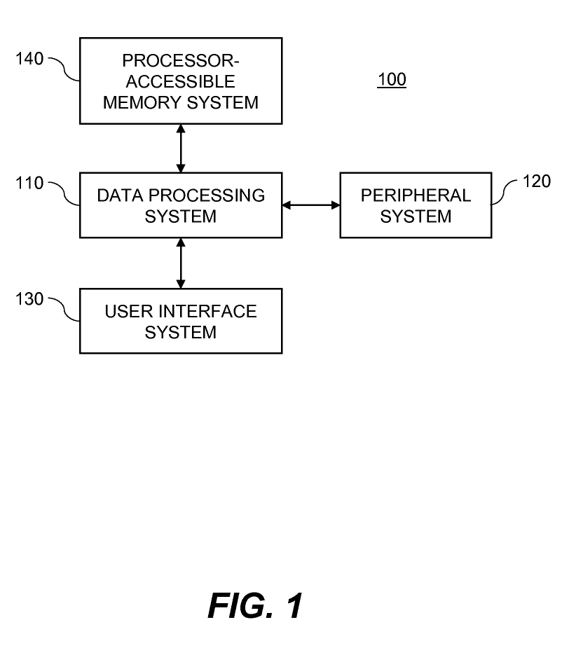

FIG. 1 illustrates a system 100 for processing geo-location information associated with a digital image file, according to an embodiment of the present invention. The system 100 includes a data processing system 110, a peripheral system 120, a user interface system 130, and a processor-accessible memory system 140. The processor-accessible memory system 140, the peripheral system 120, and the user interface system 130 are communicatively connected to the data processing system 110.

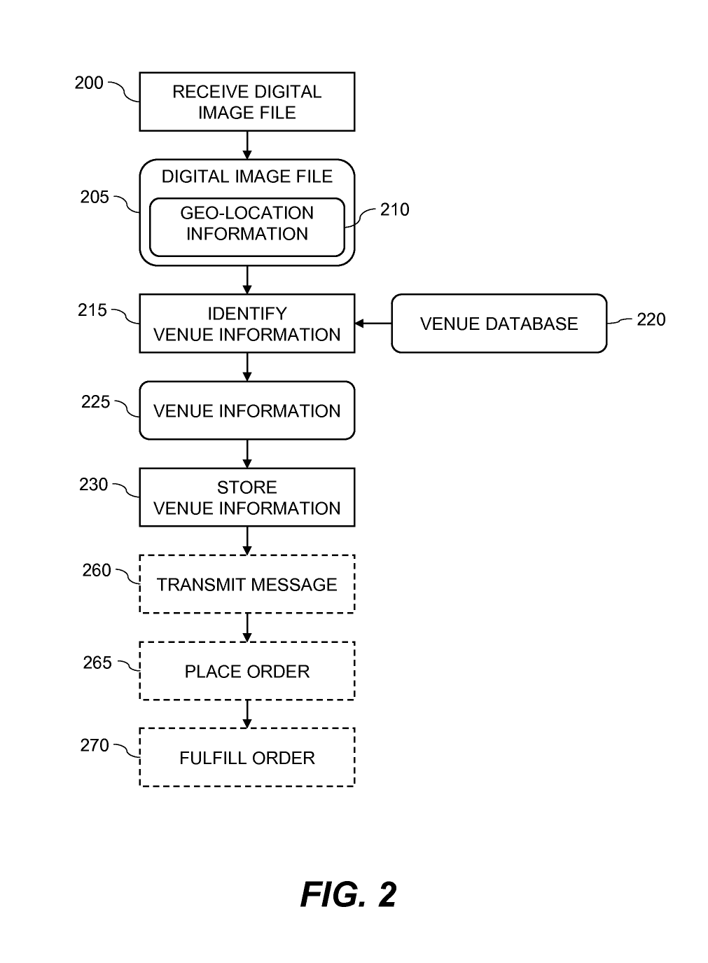

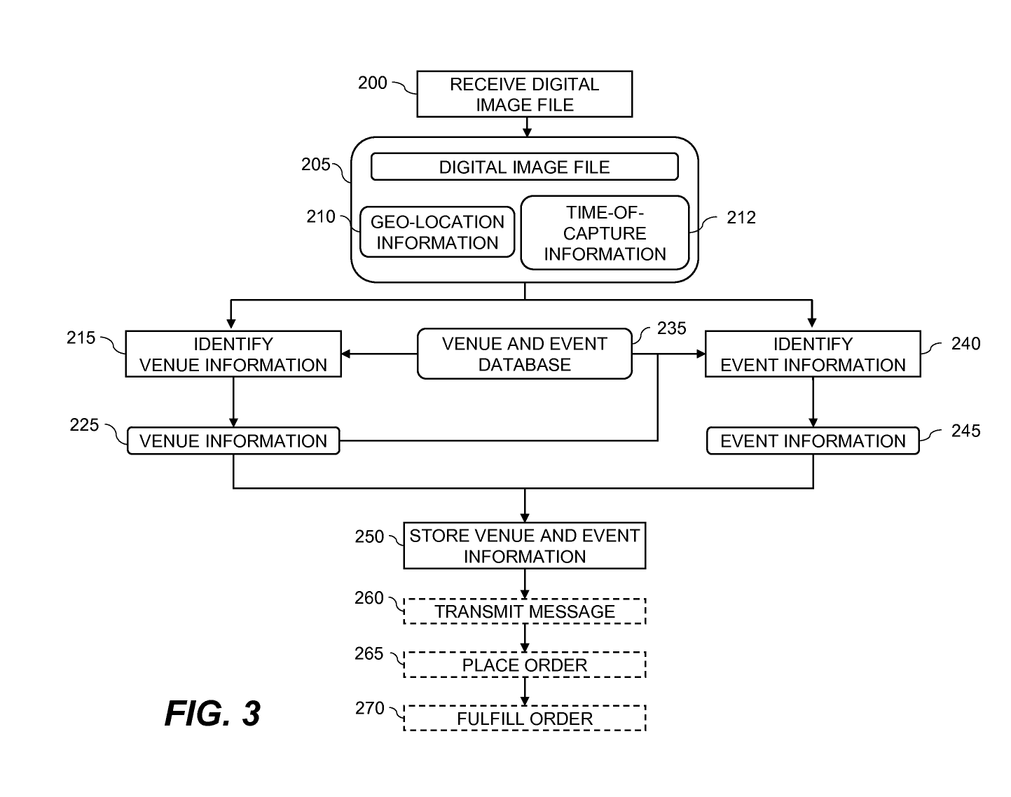

The data processing system 110 includes one or more data processing devices that implement the processes of the various embodiments of the present invention, including the example processes of FIGS. 2 and 3 described herein. The phrases “data processing device” or “data processor” are intended to include any data processing device, such as a central processing unit (“CPU”), a desktop computer, a laptop computer, a mainframe computer, a personal digital assistant, a Blackberry™, a digital camera, cellular phone, or any other device for processing data, managing data, or handling data, whether implemented with electrical, magnetic, optical, biological components, or otherwise.

The processor-accessible memory system 140 includes one or more processor-accessible memories configured to store information, including the data and instructions needed to execute the processes of the various embodiments of the present invention, including the example processes of FIGS. 2 and 3 described herein. The processor-accessible memory system 140 can be a distributed processor-accessible memory system including multiple processor-accessible memories communicatively connected to the data processing system 110 via a plurality of computers and/or devices. On the other hand, the processor-accessible memory system 140 need not be a distributed processor-accessible memory system and, consequently, can include one or more processor-accessible memories located within a single data processor or device.

The phrase “processor-accessible memory” is intended to include any processor-accessible data storage device, whether volatile or nonvolatile, electronic, magnetic, optical, or otherwise, including but not limited to, registers, floppy disks, hard disks, Compact Discs, DVDs, flash memories, ROMs, and RAMs.

The phrase “communicatively connected” is intended to include any type of connection, whether wired or wireless, between devices, data processors, or programs in which data can be communicated. Further, the phrase “communicatively connected” is intended to include a connection between devices or programs within a single data processor, a connection between devices or programs located in different data processors, and a connection between devices not located in data processors at all. In this regard, although the processor-accessible memory system 140 is shown separately from the data processing system 110, one skilled in the art will appreciate that the processor-accessible memory system 140 can be stored completely or partially within the data processing system 110. Further in this regard, although the peripheral system 120 and the user interface system 130 are shown separately from the data processing system 110, one skilled in the art will appreciate that one or both of such systems can be stored completely or partially within the data processing system 110.

The peripheral system 120 can include one or more devices configured to provide digital image files to the data processing system 110. For example, the peripheral system 120 can include digital video cameras, cellular phones, digital still-image cameras, or other data processors. The data processing system 110, upon receipt of digital image files from a device in the peripheral system 120 can store such digital image files in the processor-accessible memory system 140.

The user interface system 130 can include a mouse, a keyboard, another computer, or any device or combination of devices from which data is input to the data processing system 110. In this regard, although the peripheral system 120 is shown separately from the user interface system 130, the peripheral system 120 can be included as part of the user interface system 130. The user interface system 130 also can include a display device, a processor-accessible memory, or any device or combination of devices to which data is output by the data processing system 110. In this regard, if the user interface system 130 includes a processor-accessible memory, such memory can be part of the processor-accessible memory system 140 even though the user interface system 130 and the processor-accessible memory system 140 are shown separately in FIG. 1.

FIG. 2 depicts a flowchart of a method for processing geo-location information associated with a digital image file, according to an embodiment of the present invention. In receive digital image file step 200, a digital image file 205 with associated geo-location information 210 is received by the data processing system 110 (FIG. 1). In a preferred embodiment of the present invention, the geo-location information 210 is stored as metadata within the digital image file 205. Alternatively the geo-location information 210 may be obtained from some other associated data source stored in processor-accessible memory system 140 (FIG. 1). Examples of associated data sources include but are not limited to text files, binary files, or databases.

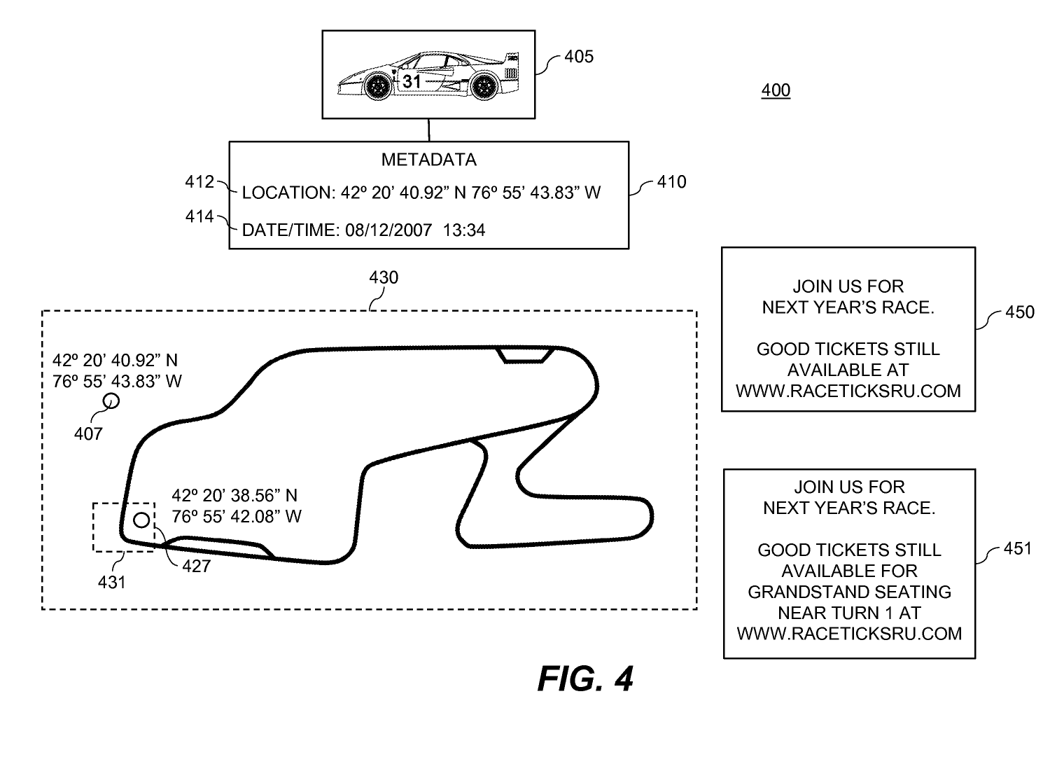

Referring to FIG. 4, an example 400 is given for illustrating the method of the present invention. A digital image 405 is shown together with associated image capture metadata 410. In a preferred embodiment of the present invention, the digital image 405 and the image capture metadata 410 are stored in digital image file 205 (FIG. 2). The image capture metadata 410 includes geo-location metadata 412 providing geo-location information 210 (FIG. 2), which indicates that the digital image 405 was captured at image capture location 407 near a racetrack venue 430.

Referring back to FIG. 2 in identify venue information step 210 the geo-location information 210 is used by the data processing system 110 (FIG. 1) to identify venue information 225 by accessing a venue database 220 stored in the processor-accessible memory system 140 (FIG. 1). The venue information 225 is an indication of the venue where the digital image file 205 was captured. The venue database can store venues such as national parks, beaches, amusement parks, sports venues, governmental buildings, schools and other points-of-interest. Venues can be represented in the venue database 220 in various ways including but not limited to location data specified by circles, rectangles and polygons. For example, when represented as a polygon, the venue can be described as a series of latitude/longitude pairs that form a closed polygon representing the geographic boundary of the venue.

In one embodiment of the present invention, identify venue information step 215 works by comparing the geo-location information 210 to each venue in the venue database 220 until a matching venue is identified (or until it is determined that no matching venues are in the database). To determine whether the geo-location information 210 matches a particular venue, the geo-location information 210 is compared to the appropriate geometric description of the venue.

For example, when the venue is represented as a circle in the venue database 220, the venue can be described as center point with a radius of defined length representing the approximate geographic boundary of the venue. A determination of whether the image capture location is inside the circle is made by measuring the distance from the image capture location to the center point of the venue circle using a distance measure such as Haversine Distance. If the distance from the image capture location to the center point is less than or equal to the radius of the venue circle, the venue is identified. When the venue is represented as a rectangle, the venue can be described as a pair of vertices representing diagonal corners of the approximate geographic boundary of the venue. A determination of whether the image capture location is inside the venue is made by comparing the image capture location with the vertices of the rectangle. Likewise, when the venue is represented as a closed polygon, a determination of whether the location is inside the polygon can be made using a standard geometric technique commonly known to those skilled in the art.

Venue information 225 identified by the identify venue information step 215 can take many different forms. In one embodiment of the present invention, venue information 225 is a text string providing a name for the identified venue. For example, the text string could be “Washington Monument” or “Yellowstone National Park” or “Upstate Racetrack.” Alternatively, the venue can be identified by other means such as an ID number corresponding to an entry in the venue database 220.

Store venue information step 215 is used to store the venue information 225 in the processor-accessible memory system 140. In a preferred embodiment of the present invention, the venue information 225 is stored as an additional metadata tag in the digital image file 205. For example, the venue information 225 can be stored as a custom venue metadata tag in accordance with the well-known EXIF image file format. Preferably, the custom venue metadata tag is a text string providing the name of the identified venue. Alternately, the venue information 225 can be stored in many other forms such as a separate data file associated with the digital image file 205, or in a database that stores information about multiple digital image files.

FIG. 2 also depicts optional steps shown with dashed lines according to an alternate embodiment of the present invention. In transmit message step 260, a message relating to the venue is transmitted to the user of the digital image. For example, if a user uploads a series of digital image files to a photo-sharing website, the website might have advertising arrangements with retailers that would offer products or services relating to various venues. In this case, a message can be transmitted to the user with an offer to purchase those products or services when an image with a corresponding venue is detected. For the example illustrated in FIG. 4, the identified venue for digital image 405 may be “Upstate Racetrack” and a message 450 may be transmitted offering tickets for the next race. Alternately, the message could be an offer to purchase other products such as racing memorabilia or a racing-themed coffee mug imprinted with user's digital image.

In another example, if the venue is identified to be a national park, a travel agency may transmit a message offering to book hotel rooms near that particular national park, or near other national parks. Alternately, a message may be transmitted offering framed photographs of the national park taken by professional photographers. In this case, the message may include photographs of the venue showing the product offerings.

In response to the product offering, the user may choose to order the product or service using place order step 265. In response the vendor will then fulfill the order with fulfill order step 270.

In another embodiment of the present invention, venues can be comprised of a plurality of portions, with each portion representing an identifiable area of the venue. In FIG. 4, venue portion 431 represents “Turn 1” of racetrack venue 430. Images captured in locations residing in portions of venues as shown with image capture location 427 residing in venue portion 431 of racetrack venue 430 will be identified by both the venue and the portion in identify venue step 215 (FIG. 2). Portions of venues can also be described in a similar fashion to the venue using polygons, circles, or rectangles. If the venue information 225 determined in identify venue step 215 includes a portion of the venue, this information can be stored in store venue information step 230. In this case, an advertisement or an image that pertains specifically to the portion of the venue can be transmitted by optional transmit message step 260. For example, message 451 in FIG. 4 illustrates a message containing an offer to purchase tickets for next year's race in the grandstand seating near Turn 1.

FIG. 3 depicts a flowchart showing method for processing geo-location information associated with a digital image file, according to another embodiment of the present invention. In this case, the digital image file 205 is received in receive digital image file step 200 that contains time-of-capture information 212 in addition to the geo-location information 210. In identify venue information step 215 venue information 225 is identified using the geo-location information 210 and a venue and event database 235 stored in the processor-accessible memory system 140 (FIG. 1). This step is carried out using the same procedure that was described earlier with respect to FIG. 2. An identify event information step 240 then uses the venue information 225 in conjunction with the time-of-capture information 212 to determine event information 245. An event is uniquely described in the venue and event database 235 by the venue together with a time interval defined by a pair of event time boundaries representing the beginning and ending of the event. The combination of location and time boundaries creates a region of space-time in which the event occurred. In the example of FIG. 4, time-of-capture metadata 414 gives the time of capture for digital image 405. This information, together with the identified racetrack venue 430, can be used to identify the particular race where the digital image was captured by comparing the capture date/time to the events in the venue and event database 235 (FIG. 3).

The identified venue information 225 and event information 245 can then be associated with the digital image file 205 and stored in the processor-accessible memory system 140 (FIG. 1) using store venue and event information step 250. In one embodiment of the present invention, the identified venue information 225 and event information 245 are stored as an additional pieces of metadata in the digital image file 205.

FIG. 3 also depicts a series of optional steps using dashed outlines. Transmit message step 260 is used to transmit a message such as an advertisement or an image pertaining to the identified event. For example, the message can be an advertisement for a souvenir program for the identified event. In some embodiments, the message relating to the event can be transmitted from a data processing system associated with a sponsor, agent, owner, or affiliate of the event or venue. A place order step 265 can then be used to order the advertised product, and the order can be fulfilled using fulfill order step 270.

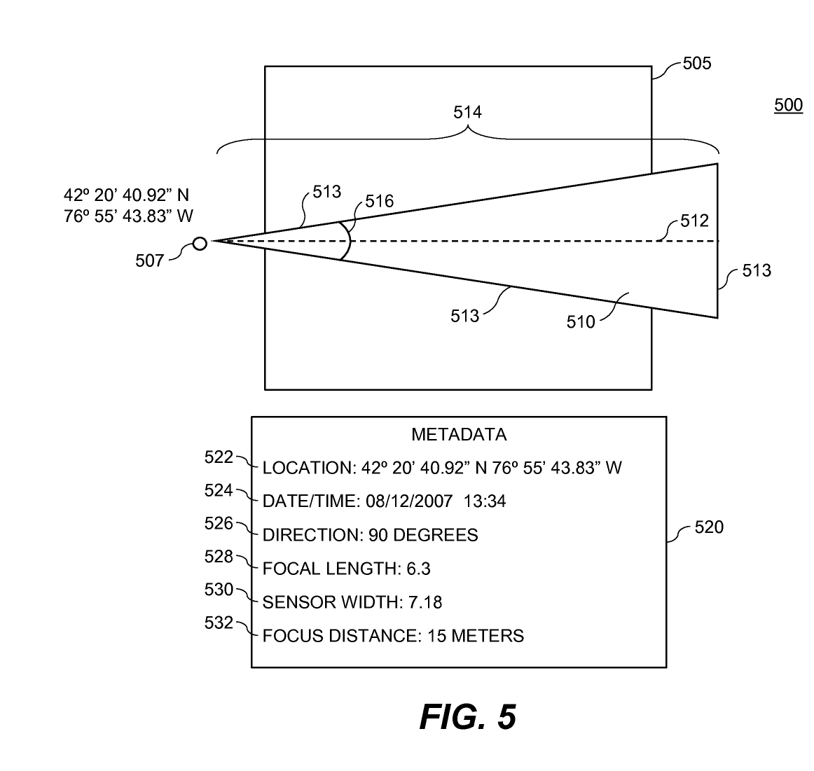

FIG. 5 illustrates an example 500 of an alternative embodiment of the present invention where other pieces of information in addition to the geo-location information are used to identify the venue or the portion of the venue. In this case, image capture metadata 520 includes geo-location metadata 522 and time-of-capture metadata 524 as before. Additionally, it includes orientation-of-capture metadata 526 relating to the direction the capture device was facing at the time of image capture, focal length metadata 528 indicating the focal length of the capture device lens system, sensor size metadata 530 indicating the width of the image sensor used to capture the digital image, and focus distance metadata 530 indicating the focus distance setting of the capture device lens system at the time of capture.

An image field-of-view (FOV) 510 with a field-of-view border 513 can be defined by the image capture location 507, image distance 514, and horizontal angle-of-view (HAOV) 516. The FOV is bisected by the center-of-view line 512. The HAOV (in degrees) can be defined by the following equation:

$$HAOV = 2 arctan ( \frac{{W}_{s}}{2 F} ) ( \frac{360}{2 π} )$$

where Wₛ is the sensor width (given by the sensor size metadata 530) and F is the focal length (given by the focal length metadata 528) of the capture device lens system. The image distance 514 can be equal to the focus distance given by the focus distance metadata 532 or some arbitrary amount larger than the focus distance to account for image content in the background of the captured image. Once an image FOV 510 has been established for a captured image it can be determined if a venue (or venue portion) 505 intersects and thus identifies the venue or portion of the venue. Geometric techniques (known to those skilled in the art) can be used to determine the intersection of the image FOV 510 with the venue 505 using either the lines defining the FOV border 513 or the center-of-view line 512. An indication of the identified venue or portion of the venue can then be stored in the processor-accessible memory system 140 (FIG. 1) as in the other embodiments that have been discussed.

It is to be understood that the exemplary embodiment(s) is/are merely illustrative of the present invention and that many variations of the above-described embodiment(s) can be devised by one skilled in the art without departing from the scope of the invention. It is therefore intended that all such variations be included within the scope of the following claims and their equivalents.

### PARTS LIST

100 System
110 Data Processing System
120 Peripheral System
130 User Interface System
140 Processor-accessible memory system
200 Receive digital image file step
205 Digital image file
210 Geo-location information
212 Time-of-capture information
215 Identify venue information step
220 Venue database
225 Venue information
230 Store venue information step
235 Venue and event database
240 Identify event information step
245 Event information
250 Store venue and event information step
260 Transmit message step
265 Place order step
270 Fulfill order step
400 Example
405 Digital image
407 Image capture location
410 Image capture metadata
412 Geo-location metadata
414 Time-of-capture metadata
427 Image capture location
430 Racetrack venue
431 Venue portion
450 Message
451 Message
500 Example
505 Venue
507 Image capture location
510 Image field-of-view
512 Center-of-view line
513 Field-of-view border
514 Image distance
516 Horizontal angle-of-view
520 Image capture metadata
522 Geo-location metadata
524 Time-of-capture metadata
526 Orientation-of-capture metadata
528 Focal length metadata
530 Sensor size metadata
532 Focus distance metadata

What is claimed is:

1. A method for processing geo-location information associated with a digital image file, the method implemented at least in part by a data processing system and comprising:
a) receiving a digital image file having at least associated geo-location information relating to the digital image file;
b) providing a venue database that stores geographic boundaries for a plurality of venues;
c) identifying a venue where the digital image file was captured, the venue being identified by at least comparing the geo-location information to the geographic boundaries stored in the venue database; and
d) adding a metadata tag to the digital image file, the metadata tag providing an indication of the identified venue.

2. The method of claim 1 wherein the metadata tag includes a text string providing an indication of the identified venue.

3. The method of claim 1 further comprising transmitting a message relating to the venue.

4. The method according to claim 3 wherein the message includes a product or service offering relating to the venue, and wherein the method further comprises:
receiving an order for the offered product or service in response to the transmitted message.

5. The method of claim 3 wherein the message includes an advertisement relating to the venue, an image of the venue, or both.

6. The method of claim 1 wherein the identifying of the venue identifies a portion of the venue using at least the geo-location information.

7. The method of claim 6 further comprising transmitting a message relating to the portion of the venue.

8. The method of claim 7 wherein the message includes an advertisement relating to the portion of the venue, an image of the portion of the venue, or both.

9. The method of claim 6 further comprising adding a metadata tag to the digital image file, the metadata tag providing an indication of the identified portion of the venue.

10. The method of claim 1 wherein the digital image file further has associated therewith time-of-capture information, and wherein the method further comprises:
e) providing an event database that stores time intervals associated with events occurring at venues stored in the venue database;
f) identifying an event at which the digital image file was captured, the event being identified by at least comparing the time-of-capture information to the time intervals stored in the event database for events occurring at the identified venue; and
g) adding a metadata tag to the digital image file, the metadata tag providing an indication of the identified event.

11. The method of claim 10 further comprising transmitting a message relating to the event.

12. The method of claim 11 wherein the message includes an advertisement relating to the event, an image of the event, or both.

13. The method of claim 11 wherein the message relating to the event is transmitted by a data processing system associated with a sponsor, agent, owner, or affiliate of the event or venue.

14. The method of claim 1 wherein the digital image file further has associated therewith orientation-of-capture information, and wherein the method further comprises identifying a portion of the venue captured by the digital image file using at least the orientation-of-capture information and the geo-location information and storing an indication of the portion of the venue in the processor-accessible memory system.

15. A processor-accessible memory system storing:
a venue database that stores geographic boundaries for a plurality of venues; and
instructions configured to cause a data processing system to implement a method for processing geo-location information associated with a digital image file, wherein the instructions comprise:
instructions for receiving a digital image file having at least associated geo-location information relating to the digital image file;
instructions for identifying a venue where the digital image file was captured, the venue being identified by at least comparing the geo-location information to the geographic boundaries stored in the venue database; and
instructions for adding a metadata tag to the digital image file, the metadata tag providing an indication of the identified venue.

16. A system comprising:
a data processing system; and
a memory system communicatively connected to the data processing system, the memory system storing:
a venue database that stores geographic boundaries for a plurality of venues; and
instructions configured to cause the data processing system to implement a method for processing geo-location information associated with a digital image file, wherein the instructions comprise:
instructions for receiving a digital image file having at least associated geo-location information relating to the digital image file;
instructions for identifying a venue where the digital image file was captured, the venue being identified by at least comparing the geo-location information to the geographic boundaries stored in the venue database; and
instructions for adding a metadata tag to the digital image file, the metadata tag providing an indication of the identified venue.
